(19) United States
(12) Patent Application Publication
(10) Pub. No.: US 2025/0134073 A1
(43) Pub. Date: May 1, 2025

(54) 3D PRINTED NEST FOR SOOTY FALCON

(71) Applicant: KING FAISAL UNIVERSITY, Al-Ahsa (SA)

(72) Inventors: MOHAMMED ALRASHEED, AL-AHSA (SA); ANHAR SAAD ALHASSAN, AL-AHSA (SA); SALEH KHALIFH ALRASHEED, AL-AHSA (SA); NASSER FAHAD ALMULHIM, AL-AHSA (SA); MOATH IBRAHIM ALSUWAYI, AL-AHSA (SA); BAYAN ABDULLAH ALJUGHAIMAN, AL-AHSA (SA)

(21) Appl. No.: 18/385,200

(22) Filed: Oct. 30, 2023

(51) Int. Cl. A01K 31/14; A01K 29/00

(52) U.S. Cl. CPC A01K 31/14; A01K 29/005

(57) ABSTRACT

A sooty falcon nest includes a column having a height of between 3 to 5 meters, and a 3D printed enclosure located on top of the column. The 3D printed enclosure is printed using indigenous material where the nest is to be positioned simulating a natural environment of the nest. The 3D printed enclosure is 10 cm wide, 10 cm high and 10 cm deep and has an opening allowing for access into the 3D printed enclosure, and to decrease temperature and humidity to avoid any popular infectious problems in falcon species that may threaten falcon chicks such as parasitic or mycotic diseases. A tracking system is located within the 3D printed enclosure, and an external monitoring device receives data from the tracking system allowing for monitoring activities within the 3D printed enclosure.

### BACKGROUND

### 1. Field

The present disclosure relates to preserving natural habitats, and particularly to a nest for birds such as the Sooty Falcon.

### 2. Description of the Related Art

Preservation of natural habitats is vital. The sooty falcon, for example, is decreasing in growth and reproduction. The natural habitat for the Sooty Falcon consists of low lands and sandy beaches on islands in the Red Sea area. There are very few mountainous areas suitable for nesting of the Sooty Falcon. Most of the suitable nesting regions are rocky outcrops, which are mostly ancient coral reefs. The lack of proper nesting regions has led to a decrease in the growth and reproduction of the Sooty Falcon in the Red Sea Islands. In addition, exposure to predators, other raptors, and hunters has been detrimental.

### SUMMARY

There is a need for nests in natural habitats of wildlife, such as the Sooty Falcon. The nests are designed to protect the falcons through 3D printing in a way inspired by nature. Each nest is 120 cm wide, 120 cm high, 120 cm deep, and is mounted on columns having a height is 3-5 meters. The nests are placed in sites suitable for the breeding of the Sooty Falcon, such as the islands of the Red Sea so that the falcon is able to reproduce and exist self-sufficiently. It is also important to have the capability to examine the falcon's ability to hunt live prey to ensure its survival and sustainability without human intervention.

A nest, in one embodiment, includes at least one column, and a 3D printed enclosure located on top of the column. The 3D printed enclosure has an opening allowing for access into the 3D printed enclosure, and to decrease temperature and humidity to avoid any popular infectious problems in falcon species that may threaten falcon chicks such as parasitic or mycotic diseases. A tracking system is located within the 3D printed enclosure allowing for monitoring activities within the 3D printed enclosure.

The 3D printed enclosure is 120 cm wide, 120 cm high and 120 cm deep.

The tracking system includes a camera located in the 3D printed enclosure. The tracking system can also include an external monitoring device that receives data from the camera, and a GPS tracking device configured to be attached to an inhabitant of the nest. The tracking system also includes an external monitoring device that receives data from the camera and GPS tracking device. The tracking system, in some embodiments, is solar powered.

The 3D printed enclosure is printed, in some embodiments, using indigenous materials where the nest is to be positioned, simulating a natural environment of the nest. The 3D printed enclosure is printed, in other embodiments, using material that is environmentally friendly and sustainable.

The column has a height of 3 to 5 meters.

A nest, in another embodiment, includes a column and a 3D printed enclosure printed using recyclable material that is environmentally friendly to where the nest is to be positioned simulating a natural environment of the nest. The 3D printed enclosure is located on top of the column, is 120 cm wide, 120 cm high and 120 cm deep, and has an opening allowing for access into the 3D printed enclosure, and to decrease temperature and humidity to avoid any popular infectious problems in falcon species that may threaten falcon chicks such as parasitic or mycotic diseases. A tracking system is located within the 3D printed enclosure allowing for monitoring activities within the enclosure. An external monitoring device receives data from the tracking system.

The tracking system may be solar powered, and can include a camera located in the 3D printed enclosure. The external monitoring device receives data from the camera. The tracking system can further include a GPS tracking device to be attached to an inhabitant of the nest. The external monitoring device can receive data from the GPS tracking device.

The column has a height of 3 to 5 meters.

A sooty falcon nest, includes a column having a height of between 3 to 5 meters. A 3D printed enclosure is printed using indigenous material where the nest is to be positioned simulating a natural environment of the nest. The 3D printed enclosure is located on top of the column, is 120 cm wide, 120 cm high and 120 cm deep, and has an opening allowing for access into the 3D printed enclosure, and to decrease temperature and humidity to avoid any popular infectious diseases. A solar powered tracking system is located within the 3D printed enclosure allowing for monitoring activities within the 3D printed enclosure. An external monitoring device receives data from the tracking system.

These and other features of the present subject matter will become readily apparent upon further review of the following specification.

### BRIEF DESCRIPTION OF THE DRAWINGS

FIGS. 1A and 1B are illustrations of a nest for a Sooty Falcon.

FIG. 2 is an illustration of a tracking system.

FIGS. 3A to 3D are illustrations of the natural habitat of the Sooty Falcon.

Similar reference characters denote corresponding features consistently throughout the attached drawings.

### DETAILED DESCRIPTION OF THE PREFERRED EMBODIMENTS

Nests are provided for wildlife in their natural habitats. The providing of nests can help foster self-sufficiency and reproduction of the wildlife.

The nests are designed to protect wildlife, such as the Sooty Falcon, through 3D printing in a way inspired by nature. The nests are designed to accommodate each different species of wildlife. In the case of the Sooty Falcon, each nest is 120 cm wide, 120 cm high, 120 cm deep, and are mounted on columns having a height of 3-5 meters. The nests are placed in sites suitable for breeding of the Sooty Falcon, such as the islands of the Red Sea so that the falcon is able to reproduce and exist self-sufficiently. It is also important to have the capability to examine the falcon's ability to hunt live prey to ensure its survival and sustainability without human intervention. The Sooty Falcon is one example, but the present subject matter is applicable to any other species of wildlife.

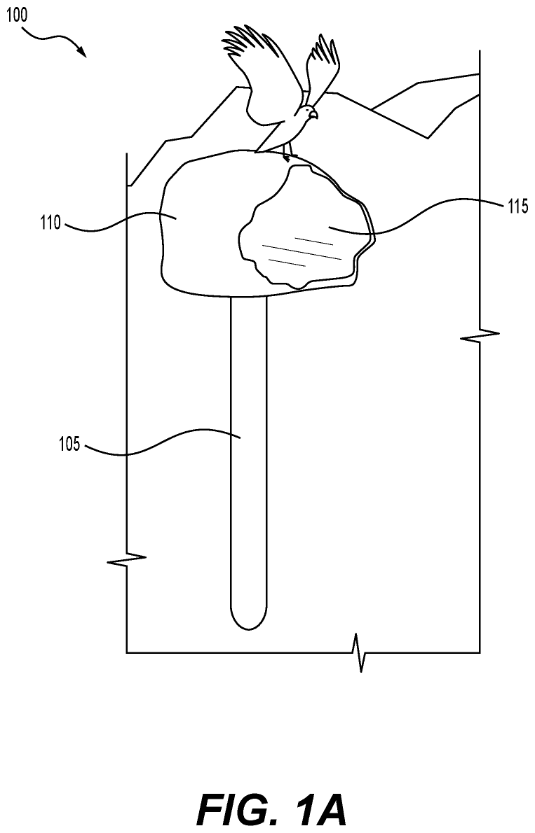

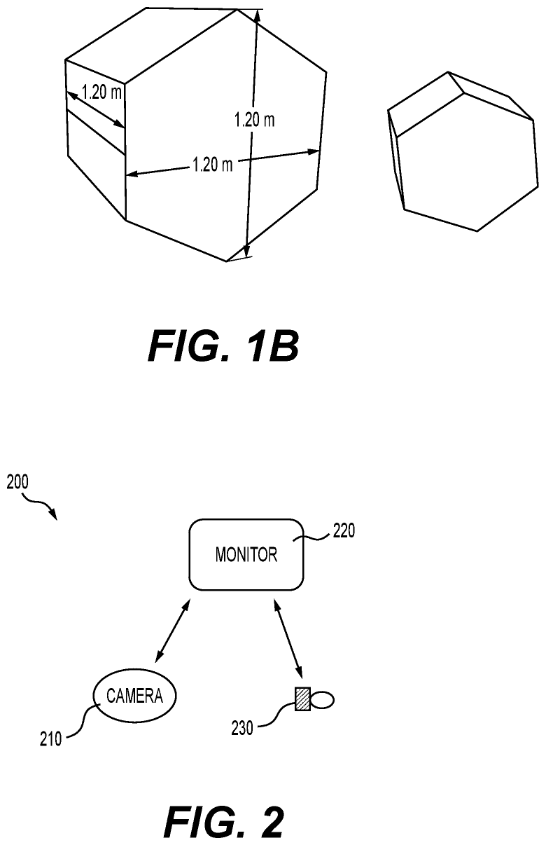

FIG. 1A is an illustration of a nest 100 for a Sooty Falcon. The nest 100 includes a column 105, and a 3D printed enclosure 110 located on top of the column 105. The 3D printed enclosure 110 has an opening 115 allowing for access into the 3D printed enclosure 110.

The 3D printed enclosure 110 is designed in proportion to the intended inhabitant. For the Sooty Falcon, the 3D printed enclosure is 120 cm wide, 120 cm high and 120 cm deep, as illustrated in FIG. 1B. However, it is contemplated that other dimensions are possible for the 3D printed enclosure if the 3D printed enclosure is to be used as a nest for different wildlife. Other dimensions contemplated range from 5-25 cm wide, 5-25 cm high and 5-25 cm deep.

A tracking system 200, illustrated in FIG. 2, allows for monitoring activities within the 3D printed enclosure 110. The tracking system 200 includes a camera 210 located in the 3D printed enclosure 110. The tracking system 200 can also include an external monitoring device 220 that receives data from the camera 210, and a GPS tracking device 230 configured to be attached to an inhabitant of the nest. The GPS tracking device 230, for example, can be attached to the foot, leg, or back of the Sooty Falcon. GPS can be used to monitor and observe the bird's movements through the GPS tracking device 230. The tracking system 200 can be solar powered. For example the GPS tracking device 230 can be solar powered as well as the camera 210.

The 3D printed enclosure 110 can be printed using indigenous materials where the nest is to be positioned, simulating a natural environment of the nest. The 3D printed enclosure 110 can also be printed using material that is environmentally friendly and sustainable.

The column 105 has a height of 3 to 5 meters. It is contemplated that the column could have a height of 2 to 10 meters or any such height within that range.

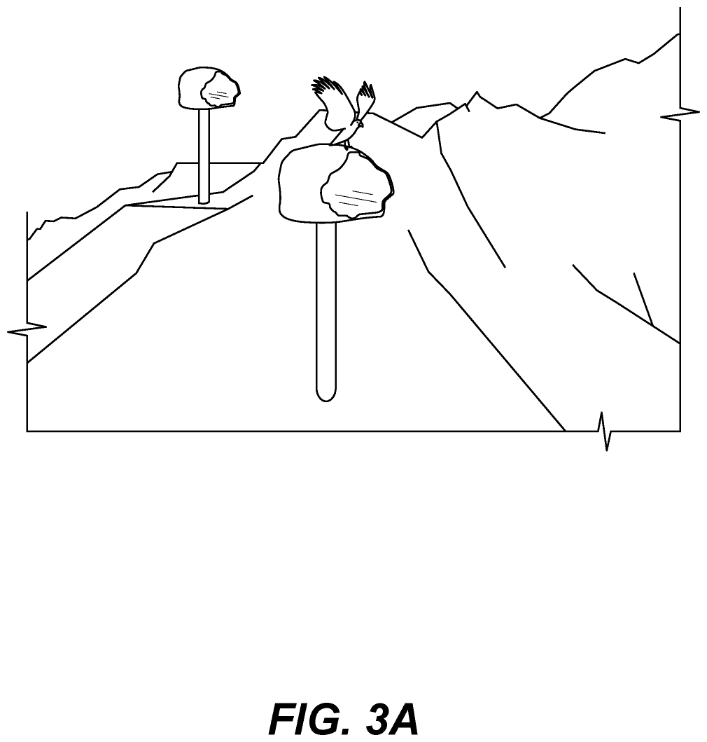

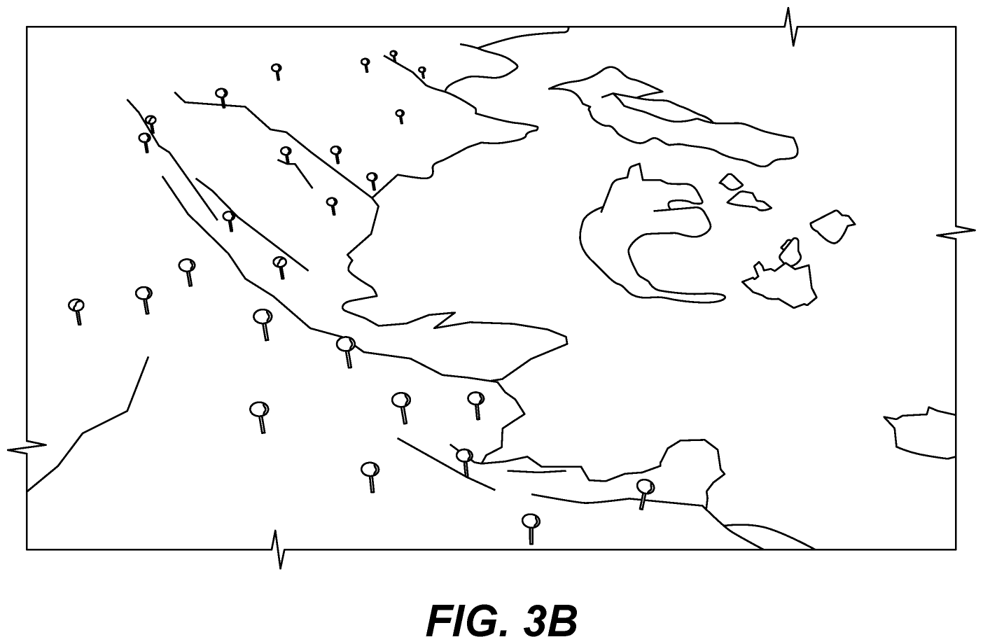

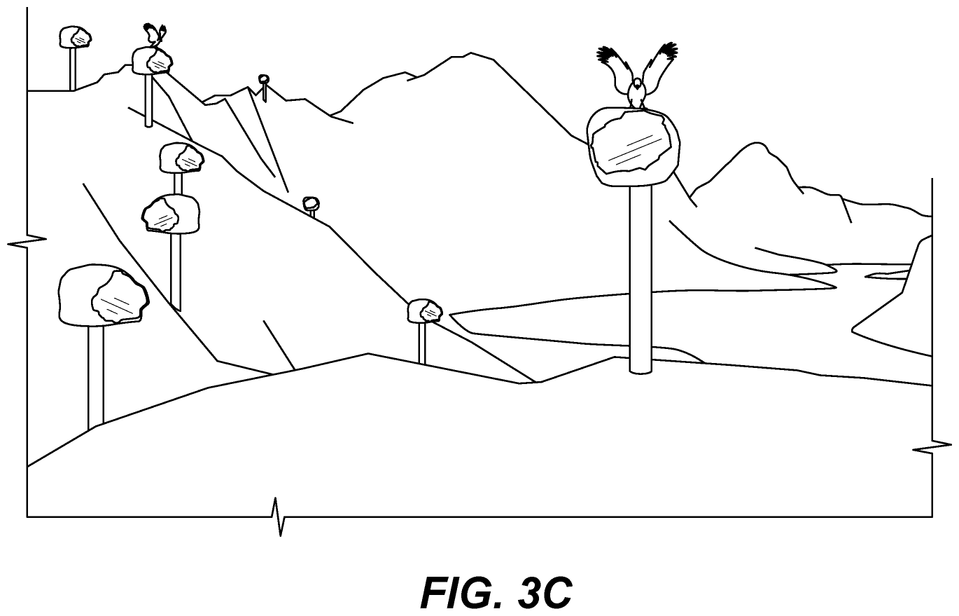

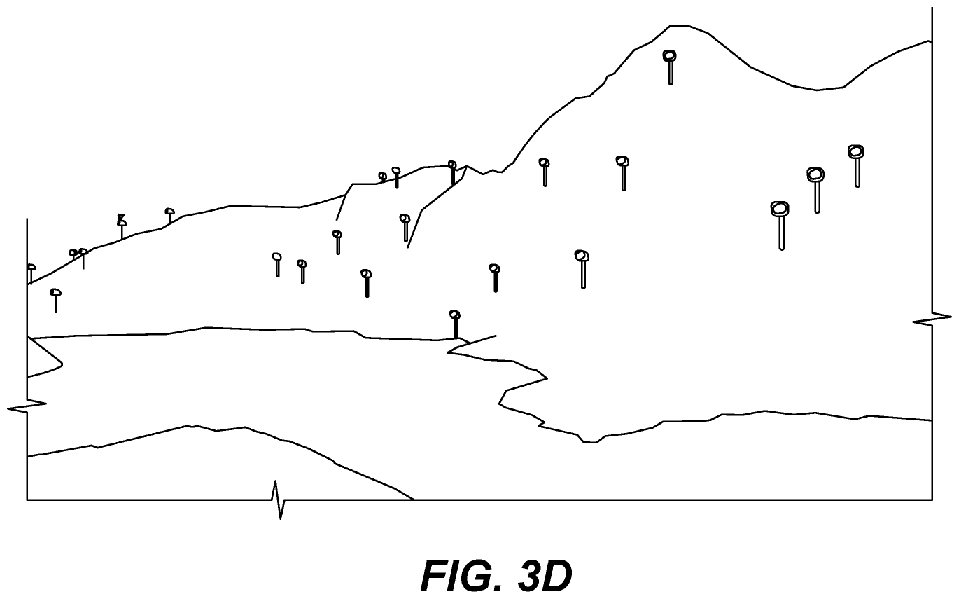

Sooty Falcons can, thus, be bred and rehabilitated in their natural habitats, which provides biodiversity and environmental sustainability. Because most of the islands consist of lowlands and sandy beaches, there are only a few mountains for breeding. There are also only a few rocky outcrops, which are mostly ancient coral reefs. This led to a decline in the growth and reproduction of this type of falcon on the Red Sea Islands. For this reason, nests are designed to protect falcons through 3D printing, inspired by nature in sites prepared for the breeding of the sooty hawk as illustrated in FIGS. 3A to 3D. Nests are placed is sites for reproduction and self-sufficiency, and verifying its ability to survive in the Red Sea Islands to enable hunting live prey to ensure its survival and sustainability without human intervention.

Organizations such as the National Centre for Wildlife, Saudi Falcons Club, through the Hadad program to rehabilitate the falcons and return them to their habitats, Natural Reserves, and Red Sea International Company will make good use of these nests.

It is to be understood that the features of the nest is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

1. A nest, comprising:
a column;
a 3D printed enclosure located on top of the column, the 3D printed enclosure having an opening allowing for access into the 3D printed enclosure, and to decrease temperature and humidity to avoid any popular infectious problems in falcon species that may threaten falcon chicks; and
a tracking system located within the 3D printed enclosure allowing for monitoring hunting activities of falcon species within the 3D printed enclosure,
wherein the tracking system is solar powered, the tracking system also including a GPS tracking device configured to be attached to an inhabitant of the nest, wherein the GPS tracking device configured to be attached to the inhabitant of the nest is also solar powered, and wherein the monitoring of hunting activities of the falcon species within the 3-D printed enclosure includes examining the falcon species ability to hunt live prey.

2. The nest as recited in claim 1, wherein the 3D printed enclosure is 120 cm wide, 120 cm high and 120 cm deep.

3. The nest as recited in claim 1, wherein the tracking system includes a camera located in the 3D printed enclosure.

4. The nest as recited in claim 3, wherein the tracking system includes an external monitoring device that receives data from the camera.

5. (canceled)

6. The nest as recited in claim 1, wherein the tracking system includes an external monitoring device that receives data from the GPS tracking device.

7. (canceled)

8. The nest as recited in claim 1, wherein the 3D printed enclosure is printed using indigenous materials where the nest is to be positioned simulating a natural environment of the nest.

9. The nest as recited in claim 1, wherein the 3D printed enclosure is printed using material that is environmentally friendly and sustainable.

10. The nest as recited in claim 1, wherein the column has a height of 3 to 5 meters

11. A nest, comprising:
a column;
a 3D printed enclosure printed using recyclable material that is environmentally friendly to where the nest is to be positioned simulating a natural environment of the nest, the 3D printed enclosure located on top of the column, being 10 cm wide, 10 cm high and 10 cm deep, and having an opening allowing for access into the 3D printed enclosure, and to decrease temperature and humidity to avoid any popular infectious problems in falcon species that may threaten falcon chicks;
a tracking system located within the 3D printed enclosure allowing for monitoring hunting activities of falcon species within the 3D printed enclosure, enclosure, wherein the tracking system is solar powered, the tracking system also including a GPS tracking device configured to be attached to an inhabitant of the nest, wherein the GPS tracking device configured to be attached to the inhabitant of the nest is also solar powered, and wherein the monitoring of hunting activities of the falcon species within the 3-D printed enclosure includes examining the falcon species ability to hunt live prey; and
an external monitoring device that receives data from the tracking system.

12. The nest as recited in claim 11, wherein the tracking system includes a camera located in the 3D printed enclosure.

13. The nest as recited in claim 12, wherein the external monitoring device receives data from the camera.

14. (canceled)

15. The nest as recited in claim 11, wherein the external monitoring device receives data from the GPS tracking device.

16. The nest as recited in claim 11, wherein the column has a height of 3 to 5 meters.

17. (canceled)

18. A sooty falcon nest, comprising:
a column having a height of between 3 to 5 meters;
a 3D printed enclosure printed using indigenous material where the nest is to be positioned simulating a natural environment of the nest, the 3D printed enclosure located on top of the column, being 120 cm wide, 120 cm high and 120 cm deep, and having an opening allowing for access into the 3D printed enclosure, and to decrease temperature and humidity to avoid any popular infectious problems in falcon species that may threaten falcon chicks;
a solar powered tracking system located within the 3D printed enclosure allowing for monitoring hunting activities of falcon species within the 3D printed enclosure, wherein the solar powered tracking system also includes a GPS tracking device configured to be attached to an inhabitant of the nest, wherein the GPS tracking device configured to be attached to the inhabitant of the nest is also solar powered, and wherein the monitoring of hunting activities of the falcon species within the 3-D printed enclosure includes examining the falcon species ability to hunt live prey; and
an external monitoring device that receives data from the tracking system.
